(19) United States
(12) Patent Application Publication
(10) Pub. No.: US 2007/0022243 A1
(43) Pub. Date: Jan. 25, 2007

(54) Method and apparatus capable of disabling authenticated operations and guaranteed secure boot in a wireless platform

(76) Inventor: John Rudelic, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/188,254

(22) Filed: Jul. 22, 2005

(51) Int. Cl. G06F 12/00; G06F 9/00; G06F 12/14

(52) U.S. Cl. 711/103; 713/2; 711/163

(57) ABSTRACT

An embodiment of the present invention provides an apparatus, comprising flash memory capable of blocking reads from a secure boot block and capable of disabling authenticated operations after a secure boot process. A configuration register may control access to the secure boot block and enable/disable the authenticated operations. An embodiment of the present invention provides that a secure NOR flash technology may utilize a resident micro-controller to perform authenticated write operations to the NOR flash. The configuration register may be reset after a hard boot thereby enabling authenticated operations and read access of the secure boot block and may be capable of being set to disable authenticated operations and read access of the secure boot block.

### BACKGROUND

Flash memory has evolved and become prevalent in wireless platforms. Flash memory is a form of electrically erasable programmable read-only memory (EEPROM) that allows multiple memory locations to be erased or written in one programming operation. Simply put, it is a form of rewritable memory chip that, unlike a Random Access Memory chip, holds its content without maintaining a power supply.

Flash memory stores information in an array of transistors, called “cells”, each of which traditionally stores one bit of information. Newer flash memory devices, sometimes referred to as multi-level cell devices, can store more than 1 bit per cell, by varying the number of electrons placed on the floating gate of a cell.

In NOR flash, each cell looks similar to a standard metal-oxide semiconductor field-effect transistor (MOSFET), except that it has two gates instead of just one. One gate is the control gate (CG) like in other MOS transistors, but the second is a floating gate (FG) that is insulated all around by an oxide layer. The FG is between the CG and the substrate. Because the FG is isolated by its insulating oxide layer, any electrons placed on it get trapped there and thus store the information. When electrons are on the FG, they modify (partially cancel out) the electric field coming from the CG, which modifies the threshold voltage (Vt) of the cell. Thus, when the cell is “read” by placing a specific voltage on the CG, electrical current will either flow or not flow, depending on the Vt of the cell, which is controlled by the number of electrons on the FG. This presence or absence of current is sensed and translated into 1's and 0's, reproducing the stored data. In a multi-level cell device, which stores more than 1 bit of information per cell, the amount of current flow will be sensed, rather than simply the presence or absence of current, in order to determine the number of electrons stored on the FG.

A NOR flash cell is programmed (set to a specified data value) by starting up electrons flowing from the source to the drain, then a large voltage placed on the CG provides a strong enough electric field to suck them up onto the FG, a process called hot-electron injection. To erase (reset to all 1's, in preparation for reprogramming) a NOR flash cell, a large voltage differential is placed between the CG and source, which pulls the electrons off through quantum tunneling. Most modern NOR flash memory components are divided into erase segments, usually called either blocks or sectors. All of the memory cells in a block must be erased at the same time. NOR programming, however, can generally be performed one byte or word at a time.

NOR flash memory is becoming even more prevalent in wireless platforms where security is of particular concern. Thus, a strong need exists for a method and apparatus capable of disabling authenticated operations and guaranteed secure boot in a wireless platform.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an apparatus of one embodiment of the present invention with an authorized entity and flash memory, with message transmission environment there between;

FIG. 2 is a diagram illustrating the functionality of the secure flash during secure and normal mode of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Secure NOR flash technology has recently been developed. Secure NOR flash technology may utilize a resident micro-controller to perform authenticated write operations to the NOR flash—although the present invention is not limited in this respect. Authenticated writes are flash program operations that include additional information that may used by a flash micro-controller to authenticate the entity requesting the authenticated operation. The additional information may range from public/private asymmetric key cryptography to simple password protection. The secure NOR flash will not perform the operation unless the authentication by the flash memory is successful. The authenticated write operations can prevent unwanted operations to the flash memory. However, even flash with the authenticated write operations may be attacked.

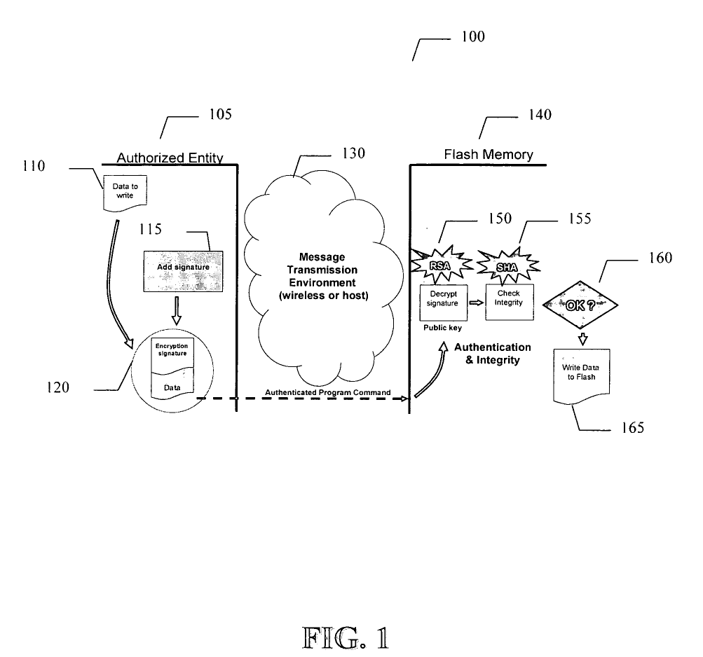

Turning now to FIG. 1, shown generally as 100, is a diagram showing the operation of the authenticated operations. The Authorized entity 105 (carrier or the host platform) provides some meta-information (such as an RSA signature) to the flash memory in addition to the data 110 to program. The flash memory will internally authenticate the request and if the request is authentic, the flash memory will proceed with the request. Authentication may be accomplished by adding a signature 115 with encryption 120 transmitted with data over message transmission environment 130 to flash memory 140. An embodiment of the present invention provides that the flash memory may include decryption signature 150 with an integrity check 155 and if okay at 160 the data may be written to the flash memory at 165.

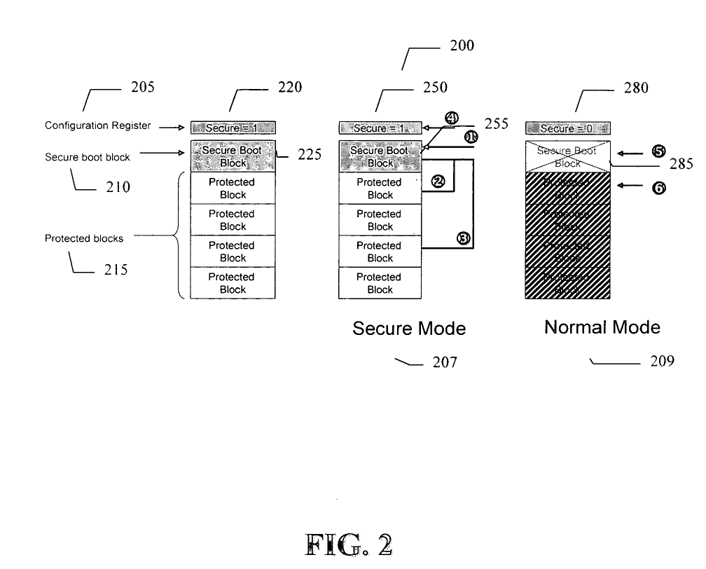

Turning now to FIG. 2, generally depicted as 200 is an embodiment of the present invention which provides a mechanism to block reads from the secure boot block 225 and a mechanism to disable the authenticated operations after the secure boot process. The system may initialize after a hard boot with the secure boot block 225 available and the authenticated operations enabled. After the system completes the secure boot process, the secure boot block will be unavailable and the authenticated operations will be disabled. Locking the authenticated write operations and disabling reads from the secure boot block eliminates the opportunity for an attack on the protected code. A configuration register 205 may be added that will be reset after a hard boot, thereby enabling authenticated operations and read access of the secure boot block, and may be set by the application (disabling authenticated operations and read access of the secure boot block).

An embodiment of the present invention may guarantee the integrity of the secure boot process. The secure boot block 210 may only be available to the host during the secure boot phase of the system boot. After the system has booted into normal mode, the secure boot block 210 is no longer available for read access. Disabling access to the secure boot block 210 eliminates the opportunity to read/modify or hack at the secure boot lock. An embodiment of the present invention may also guarantee integrity of the authenticated code within the system by disabling authenticated writes after the system has securely booted. Code updates may be guaranteed to only happen during the secure boot process. Disabling authenticated operations after the system has securely booted eliminates the opportunity for an attacker to send authentic, but incorrect information to the flash memory. Secure mode is illustrated at 207 with secure boot block of secure mode shown at 255 and configuration register (set to 1) of secure mode at 250. Whereas normal mode is depicted at 209 with secure boot block of normal mode shown at 285 and configuration register (set to 0) of secure mode at 280. Protected blocks for all modes are shown generally as 215.

In an embodiment of the present invention, FIG. 2 illustrates the method of operation and the flash memory that may be utilized in the present invention. The configuration register 205 controls access to the secure boot block 210 and enables/disables the authenticated operations. The configuration register 205 is set (=1) after a hard boot which enables read access to the secure boot block and enables the authenticated operation on the protected blocks. The application of the secure boot process can reset (=0) the configuration register which disables read access to the secure boot block and disables the authenticated operations.

The secure boot block 210 may be protected with authenticated operations. Read access and authenticated operations may now be controlled by the state of the configuration register. The protected blocks 215 are protected with the authenticated operations. Authenticated operations are now controlled by the state of the configuration register 205. The secure state is illustrated at 207 and in the secure state the configuration register 250 is set (=1). This state is entered after a hard reset or power reset. In the secure state, reads of the secure boot block 255 are permitted. The secure boot block 255 can also perform authenticated operations on the protected blocks in the system. Over the air (OTA) updates would be performed in the secure state from the secure boot block 255. Once the secure boot process is complete, the system may copy the vector table to a new location or configure the base vector register to point to a location in a protected block. The system may then reset the configuration register 250, causing the system to enter normal mode 209. In normal mode 209, reads of the secure boot block 285 and authenticated operations are not permitted.

In normal mode 209, where configuration register 280 is set to (=0), read access to the secure boot block 285 is not permitted and authenticated operations on the secure boot block 285 and the protected blocks are not permitted.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
flash memory capable of blocking reads from a secure boot block and capable of disabling authenticated operations after a secure boot process.

2. The apparatus of claim 1, wherein a configuration register controls access to said secure boot block and enables/disables said authenticated operations.

3. The apparatus of claim 1, wherein said flash memory is a secure NOR flash.

4. The apparatus of claim 3, wherein said secure NOR flash technology utilizes a resident micro-controller to perform authenticated write operations to said NOR flash.

5. The apparatus of claim 1, wherein said flash further is further capable of using Authenticated writes.

6. The apparatus of claim 1, wherein said apparatus initializes after a hard boot with the secure boot block available and the authenticated operations enabled and wherein after said apparatus completes said secure boot process said secure boot block will be unavailable and the authenticated operations will be disabled.

7. The apparatus of claim 2, wherein said configuration register will be reset after a hard boot thereby enabling authenticated operations and read access of said secure boot block and is capable of being set to disable authenticated operations and read access of said secure boot block.

8. A method comprising:
blocking reads from a secure boot block and disabling authenticated operations after a secure boot process in a flash memory.

9. The method of claim 8, further comprising controlling access and enabling/disabling said authenticated operations to said secure boot block.

10. The method of claim 9, wherein said flash memory is a secure NOR flash.

11. The method of claim 10, further comprising utilizing a resident micro-controller to perform authenticated write operations to said NOR flash.

12. The method of claim 8, further comprising using Authenticated writes by said flash memory.

13. The method of claim 8, further comprising initializing after a hard boot with the secure boot block available and the authenticated operations enabled and after completing said secure boot process said secure boot block will be unavailable and the authenticated operations will be disabled.

14. The method of claim 8, further comprising resetting said configuration register after a hard boot thereby enabling authenticated operations and read access of said secure boot block.

15. An article comprising a machine-accessible medium having one or more associated instructions, which if executed, results in blocking reads from a secure boot block and disabling authenticated operations after a secure boot process in a flash memory.

16. The article of claim 15, further comprising controlling access and enabling/disabling said authenticated operations to said secure boot block.

17. The article of claim 16, wherein said flash memory is a secure NOR flash.

18. The article of claim 17, further comprising utilizing a resident micro-controller to perform authenticated write operations to said NOR flash.

19. The article of claim 15, further comprising using Authenticated writes by said flash memory.

20. The article of claim 15, further comprising initializing after a hard boot with the secure boot block available and the authenticated operations enabled and after completing said secure boot process said secure boot block will be unavailable and the completing said secure boot process said secure boot block will be unavailable and the authenticated operations will be disabled.

21. The article of claim 15, wherein said article further controls the resetting of said configuration register after a hard boot thereby enabling authenticated operations and read access of said secure boot block.
